(19) United States
(12) Patent Application Publication
(10) Pub. No.: US 2022/0194418 A1
(43) Pub. Date: Jun. 23, 2022

(54) AUTOMATIC DRIVING VEHICLE

(71) Applicant: TOYOTA JIDOSHA KABUSHIKI KAISHA, Toyota-shi Aichi-ken (JP)

(72) Inventor: Hirohito Ide, Nagoya-shi Aichi-ken (JP)

(73) Assignee: TOYOTA JIDOSHA KABUSHIKI KAISHA, Toyota-shi Aichi-ken (JP)

(21) Appl. No.: 17/524,250

(22) Filed: Nov. 11, 2021

(30) Foreign Application Priority Data
Dec. 18, 2020 (JP) 2020-209817

(51) Int. Cl. B60W 60/00; B60W 50/14; B60K 35/00

(52) U.S. Cl. CPC B60W 60/005; B60W 50/14; B60W 2540/215; B60W 2050/146; B60K 35/00

(57) ABSTRACT

An automatic driving vehicle includes a vehicle position estimation device that estimates a vehicle position, a touch panel that is capable of being visually recognized by an operator, and a control device that controls behaviors of the vehicle position estimation device and the touch panel, and the control device displays a behavior state of the vehicle position estimation device by blinking an automatic mode selection button and a semi-automatic mode selection button on the touch panel.

### CROSS-REFERENCE TO RELATED APPLICATION

This application claims priority to Japanese Patent Application No. 2020-209817 filed on Dec. 18, 2020, incorporated herein by reference in its entirety.

### BACKGROUND

### 1. Technical Field

The present disclosure relates to a configuration of an automatic driving vehicle equipped with a vehicle position estimation device.

### 2. Description of Related Art

In automatic driving, it is necessary to accurately estimate a vehicle position. Therefore, there has been proposed a method of generating a road surface image at the vehicle position from vehicle position information and map information, picking up an actual image of a road surface using a camera equipped in the vehicle, and checking the estimation accuracy for the vehicle position based on the difference between the generated road surface image and the picked actual image of the road surface (see Japanese Unexamined Patent Application Publication No. 2018-77771). The vehicle position information is estimated based on a signal from a GPS receiver and a signal from a sensor that detects a traveling state of the vehicle.

### SUMMARY

In automatic driving vehicles, an operator sometimes switches a traveling control mode to a manual mode, to perform manual driving. At the time of switching from the manual driving to automatic driving, the operator need cause a vehicle position estimation device to behave and complete a vehicle position estimation behavior before start of the automatic driving. For the estimation of the vehicle position, for example, the position and oriented direction of the vehicle on an in-vehicle map for the automatic driving are estimated based on outputs from a GPS receiver, a sensor to detect the traveling state and a physical body detection sensor, an image from a camera, and the like.

The execution of the vehicle position estimation behavior requires a long time, because the accurate position and direction of the vehicle is determined based on outputs from a plurality of sensors and image information. Therefore, it is necessary to start the execution of the behavior well before the start of the automatic driving, and it is necessary to cause the operator to recognize a behavior state of the vehicle position estimation device when the operator is performing the manual driving before the start of the automatic driving.

Hence, the present disclosure has an object to cause the operator to recognize the behavior state of the vehicle position estimation device in the automatic driving vehicle.

An automatic driving vehicle in the present disclosure is an automatic driving vehicle including: a vehicle position estimation device that estimates a vehicle position; a display device that is capable of being visually recognized by an operator; and a control device that controls behaviors of the vehicle position estimation device and the display device, in which the control device causes the display device to display a behavior state of the vehicle position estimation device.

In this way, the control device causes the display device capable of being visually recognized by the operator to display the behavior state of the vehicle position estimation device. Therefore, it is possible to cause the operator to recognize the behavior state of the vehicle position estimation device.

In the automatic driving vehicle in the present disclosure, the control device may perform traveling control, and may be capable of switching a traveling control mode between an automatic mode and a manual mode, and the control device may give notice that the vehicle position estimation device is in an execution standby state, to the operator, when the vehicle position estimation device has not completed a vehicle position estimation behavior in a state where the traveling control mode is the manual mode.

Thereby, it is possible to cause the operator to recognize that the vehicle position estimation device is in the standby state, and it is possible to prompt the operator to cause the vehicle position estimation device to behave and execute the vehicle position estimation behavior before the start of the automatic driving.

In the automatic driving vehicle in the present disclosure, the display device may be a GUI device including a screen on which an operation element is displayed, the GUI device accepting an operation by the operator when the operator selects the operation element, and the control device may cause the display device to display another operation element by which the operator selects execution or stop of the vehicle position estimation behavior, when the vehicle position estimation device has not completed the vehicle position estimation behavior in the state where the traveling control mode is the manual mode.

Thereby, it is possible to cause the operator to recognize that the vehicle position estimation device has not completed the vehicle position estimation behavior, and it is possible to prompt the operator to cause the vehicle position estimation device to behave and execute the vehicle position estimation behavior before the start of the automatic driving.

In the automatic driving vehicle in the present disclosure, the display device may be a GUI device including a screen on which an operation element is displayed, the GUI device accepting an operation by the operator when the operator selects the operation element, the control device may be capable of switching a traveling control mode between an automatic mode and a manual mode, and may perform traveling control based on an operation by the operator that is accepted by the display device, when the traveling control mode is the manual mode, and the control device may stop a vehicle position estimation behavior in the vehicle position estimation device, in a case where an operation to start traveling is input from the display device when the vehicle position estimation device is executing the vehicle position estimation behavior during vehicle stop in a state where the traveling control mode is the manual mode.

It is possible to avoid decrease in the estimation accuracy for the vehicle position when the automatic driving vehicle starts traveling in response to the operation by the operator while the vehicle position estimation device is executing the vehicle position estimation behavior.

In the automatic driving vehicle in the present disclosure, the control device may perform traveling control, and may be capable of switching a traveling control mode between an automatic mode and a manual mode, and the control device may cause the vehicle position estimation device to execute a vehicle position estimation behavior during vehicle stop at a predetermined position for which position information is known, in a state where the traveling control mode is the manual mode.

Even when a GPS receiver cannot receive signals from GPS satellites, it is possible to estimate the position of the vehicle on an in-vehicle map for the automatic driving, by estimating the vehicle position during the vehicle stop at the predetermined position for which the position information is known.

The present disclosure makes it possible to cause the operator to recognize the behavior state of the vehicle position estimation device in the automatic driving vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external view of an automatic driving vehicle in an embodiment;

FIG. 2 is a block diagram showing the configuration of the automatic driving vehicle in the embodiment;

FIG. 3 is a perspective view of a vehicle cabin of the automatic driving vehicle in the embodiment as viewed from a front side of the automatic driving vehicle to a rear side of the automatic driving vehicle;

FIG. 4 is a perspective view of the vehicle cabin on the front side of the automatic driving vehicle in the embodiment;

FIG. 5 is a plan view showing a screen of a touch panel and an emergency stop button shown in FIG. 4;

FIG. 6 is a plan view showing dispositions of physical body detection sensors for the automatic driving vehicle in the embodiment;

FIG. 7 is a diagram schematically showing a management route and a garage for the automatic driving vehicle in the embodiment;

FIG. 8 is a flowchart showing a preliminary behavior before start of automatic driving of the automatic driving vehicle in the embodiment;

FIG. 9 is a diagram showing a screen of the touch panel in the case where a vehicle position estimation device of the automatic driving vehicle in the embodiment has not executed a vehicle position estimation behavior and where the automatic driving vehicle is being driven in a manual mode;

FIG. 10 is a diagram showing a screen of the touch panel in the case where the automatic driving vehicle in the embodiment stops at a vehicle entrance box and where the vehicle position estimation device is in an execution standby state; and

FIG. 11 is a diagram showing a screen of the touch panel in the case where the vehicle position estimation device of the automatic driving vehicle in the embodiment is executing the vehicle position estimation behavior or in the case where the vehicle position estimation device of the automatic driving vehicle in the embodiment has completed the vehicle position estimation behavior.

### DETAILED DESCRIPTION OF EMBODIMENTS

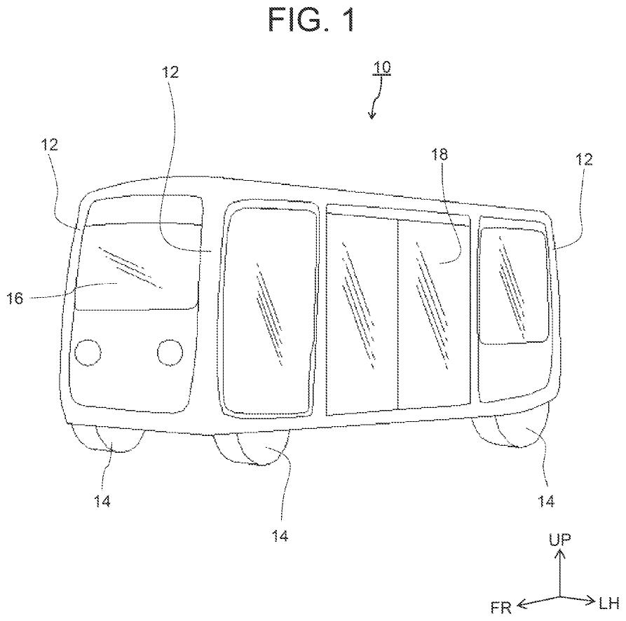

An automatic driving vehicle 10 in an embodiment will be described below with reference to the drawings. FIG. 1 is an external view of the automatic driving vehicle 10 according to the embodiment. Descriptions will be made below, assuming that the automatic driving vehicle 10 is an electric bus that transports passengers while traveling by automatic driving. In each figure of the present specification, terms “forward (FR)” and “rearward” means “forward” and “rearward” in a vehicle front-rear direction, terms “leftward (LH)” and “rightward” mean “leftward” and “rightward” when the automatic driving vehicle 10 is oriented forward, and terms “upward (UP)” and “downward” mean “upward” and “downward” in a vehicle-height direction.

As shown in FIG. 1, the automatic driving vehicle 10 has a roughly rectangular parallelepiped shape and has a front-rear symmetric shape, and the external design also has a front-rear symmetric shape. Pillars 12 extending in an up-down direction are provided at four corners in planar view, and wheels 14 are provided below the pillars 12. A large part of each of front, rear, right and left sidewalls of the automatic driving vehicle 10 is formed by a translucent panel 16. The panel 16 may be a display panel, and characters and others may be displayed on the display panel.

A panel that is a part of the left side surface is a slidable door 18, and the door 18 is slid and opened, so that an occupant can get on or get off the automatic driving vehicle 10. Although not illustrated in FIG. 1, a slope that can be taken in and out is stored below the door 18. The slope is used, for example, when a person in a wheelchair gets on or gets off the automatic driving vehicle 10.

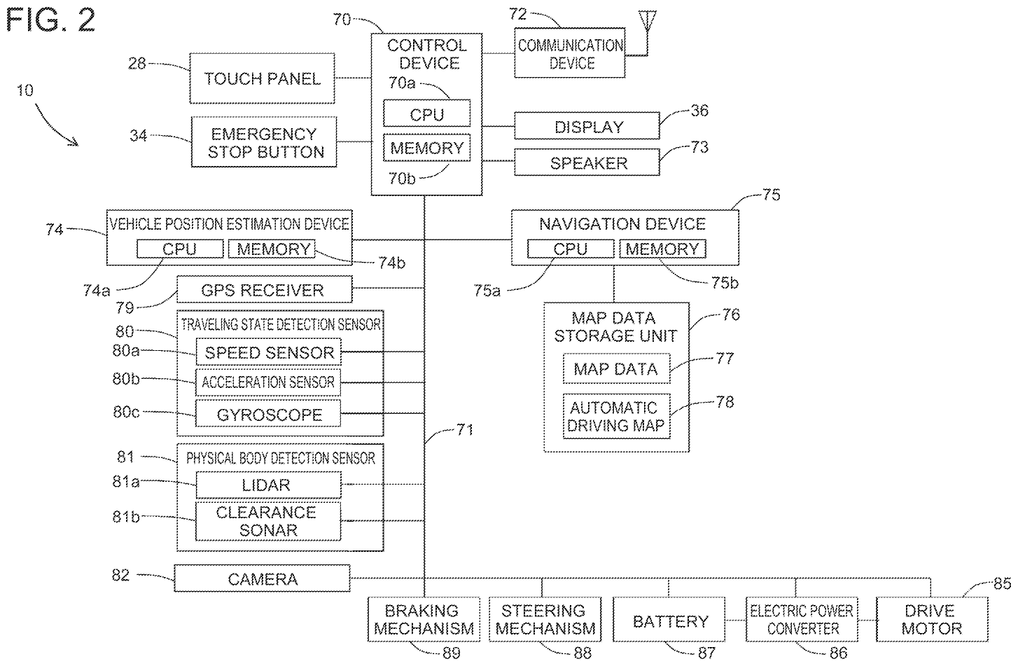

FIG. 2 is a block diagram showing the configuration of the automatic driving vehicle 10. As shown in FIG. 2, the automatic driving vehicle 10 is an electric vehicle including a drive motor 85, a battery 87 and an electric power converter 86, and travels by converting a direct-current power from the battery 87 into a desired alternating-current power using the electric power converter 86 and driving the drive motor 85. Further, the automatic driving vehicle 10 includes a steering mechanism 88 that controls steering of the vehicle and a braking mechanism 89 that controls deceleration and stop of the vehicle. The drive motor 85, the electric power converter 86, the battery 87, the steering mechanism 88, the braking mechanism 89 are connected with a control device 70 through a data bus 71, and behaves in accordance with commands from the control device 70.

The automatic driving vehicle 10 includes a communication device 72, a touch panel 28 and an emergency stop button 34 that are input devices, and a display 36 and a speaker 73 that are output devices.

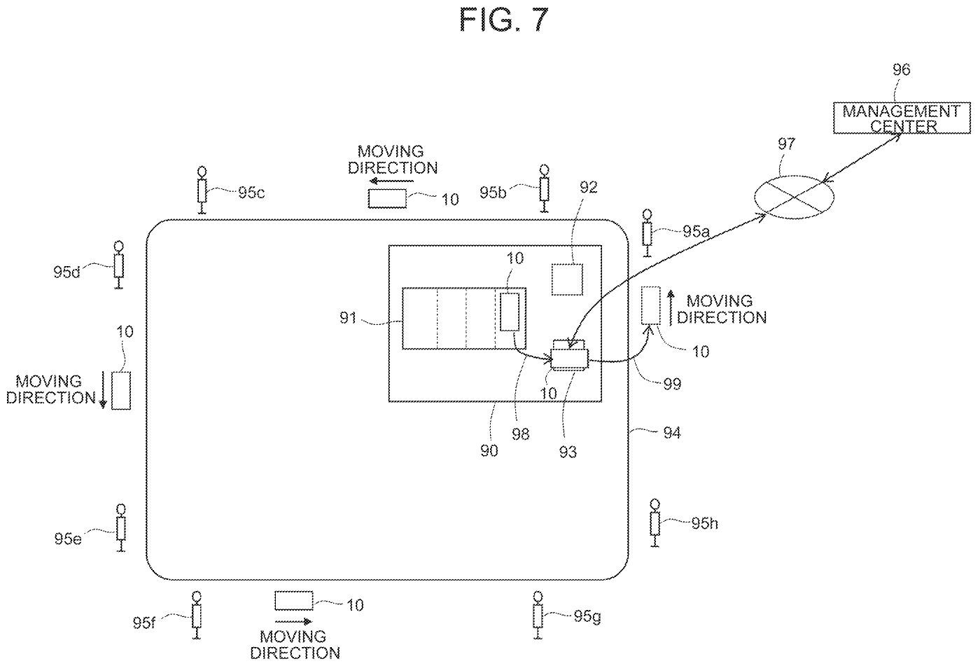

The communication device 72 communicates with an external device or a management center 96 (see FIG. 7). The communication device 72 receives external information or information such as a traveling schedule from the management center 96, to input the received information to the control device 70, and sends position information of the vehicle and the like to the management center 96.

The touch panel 28 and the emergency stop button 34 are input devices that input commands about traveling to the control device 70. The touch panel 28 is a display device including a screen on which an operation element is displayed, and is a GUI device that accepts an operation by an operator when the operator selects the operation element. Details of the screen of the touch panel 28 will be described later. The emergency stop button 34 inputs an emergency stop command to the control device 70 in response to an operation by the operator.

The display 36 is a display device that is connected with the control device 70 and that displays a variety of information relevant to the automatic driving vehicle 10. For example, information such as the vehicle speed, the ambient temperature and the next station is displayed on the display 36. The speaker 73 is connected with the control device 70, similarly to the display 36, and outputs voice guidance for information about the next station, and the like.

The automatic driving vehicle 10 is equipped with a GPS receiver 79 that acquires a variety of data for executing the automatic driving, a traveling state detection sensor 80, a physical body detection sensor 81, a camera 82, a vehicle position estimation device 74, and a navigation device 75.

The GPS receiver 79 receives signals from a plurality of GPS satellites, and thereby, detects the absolute position of the automatic driving vehicle 10, for example, the latitude and longitude of the position of the automatic driving vehicle 10. Information about the detected absolute position is output to the vehicle position estimation device 74, the control device 70 and the navigation device 75 through the data bus 71.

The traveling state detection sensor 80 includes a speed sensor 80a, an acceleration sensor 80b and a gyroscope 80c that detect a traveling state. Data detected by the sensors 80a, 80b and the gyroscope 80c is output to the vehicle position estimation device 74 and the control device 70 through the data bus 71.

The physical body detection sensor 81 detects the position of a physical body that exists in the periphery of the automatic driving vehicle 10. The physical body detection sensor 81 includes a LIDAR 81a and a clearance sonar 81b. The LIDAR 81a is an abbreviation of “Light Detection and Ranging”, and is a sensor that performs physical body detection and measurement of the distance to an object by a remote sensing technology using light. The clearance sonar 81b is a sensor that detects a physical body using ultrasonic waves. Data detected by the LIDAR 81a and the clearance sonar 81b is output to the vehicle position estimation device 74 and the control device 70 through the data bus 71. Dispositions of the LIDAR 81a and the clearance sonar 81b will be described later in detail.

The camera 82 picks up an image of the periphery of the automatic driving vehicle 10, and outputs the picked image data to the vehicle position estimation device 74 and the control device 70 through the data bus 71.

The vehicle position estimation device 74 estimates the vehicle position based on outputs from one or more of the GPS receiver 79, the traveling state detection sensor 80, the physical body detection sensor 81 and the camera 82 that are connected through the data bus 71, and outputs the estimated vehicle position to the control device 70. For the vehicle position estimation behavior, the position and oriented direction of the automatic driving vehicle 10 on an automatic driving map 78 stored in a map data storage unit 76 described later are estimated based on the outputs from the GPS receiver 79, the traveling state detection sensor 80 and the physical body detection sensor 81, and the image from the camera 82. The vehicle position estimation device 74 is a computer including a CPU 74a that performs information processing and a memory 74b in which behavior programs and behavior data are stored, in the interior of the computer.

The navigation device 75 includes a map data storage unit 76, and has functions such as display of a map of the periphery of the current place and route setting using route search. In the map data storage unit 76, general map data 77 that is used for traveling in a manual mode and the automatic driving map 78 containing detailed road information about an area where the automatic driving is executed are stored. The map data 77 and the automatic driving map 78 may be supplied from the exterior through the communication device 72. The navigation device 75 is connected with the vehicle position estimation device 74 and the control device 70 through the data bus 71. The navigation device 75 is a computer including a CPU 75a that is a processor to perform information processing and a memory 75b in which behavior programs, data and the like are stored, in the interior of the computer.

The control device 70 controls the whole behavior including the traveling of the automatic driving vehicle 10. The control device 70 is a computer including a CPU 70a that is a processor to perform information processing and a memory 70b in which control programs and control data are stored, in the interior of the computer.

The control device 70 receives commands for traveling, from the touch panel 28 and the emergency stop button 34. Further, the control device 70 receives a variety of external information from the communication device 72, and receives the traveling schedule and the like from the management center 96. Furthermore, the control device 70 receives the estimated position information about the automatic driving vehicle 10 from the vehicle position estimation device 74, receives the position information about the physical body in the periphery of the automatic driving vehicle 10 from the physical body detection sensor 81, and receives the image of the periphery of the automatic driving vehicle 10 from the camera 82. The control device 70 causes the automatic driving vehicle 10 to travel by controlling the drive motor 85, the electric power converter 86, the battery 87, the steering mechanism 88 and the braking mechanism 89 based on the estimated position information about the automatic driving vehicle 10 from the vehicle position estimation device 74, the image input from the physical detection sensor 81 or the camera 82, and the commands for traveling from the touch panel 28 and the emergency stop button 34.

The control device 70 can perform traveling control of the automatic driving vehicle 10 in three traveling control modes: an automatic mode, a semi-automatic mode and a manual mode. The automatic mode is a traveling control mode in which the control device 70 performs the traveling control of the automatic driving vehicle 10. In the automatic mode, the control device 70 performs a start control, stop control, acceleration-deceleration control, gearshift control and steering control of the automatic driving vehicle 10. Thereby, the traveling control is performed such that the target position is the position of the automatic driving vehicle 10 that is estimated by the vehicle position estimation device 74, and the automatic driving vehicle 10 can automatically travel along a set route.

The semi-automatic mode is a traveling control mode for a case where a communication malfunction or the like has occurred, and is a traveling control mode in which a part of the traveling control of the control device 70 is restricted. For example, the acceleration during traveling is performed through the operation by the operator, and the deceleration is performed by the control device 70. In the semi-automatic mode, the acceleration may be performed to a predetermined speed by the control device 70 at the time of start, and the acceleration after that may be performed by the operator.

The manual mode is a traveling control mode in which the automatic driving vehicle 10 does not perform the automatic driving and in which the acceleration-deceleration and the steering are performed through the operation by the operator that rides on the automatic driving vehicle 10.

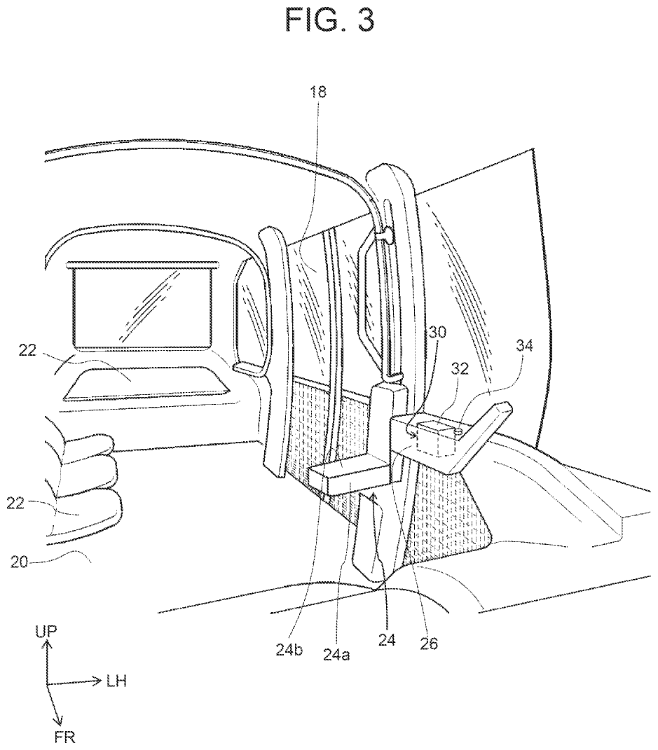

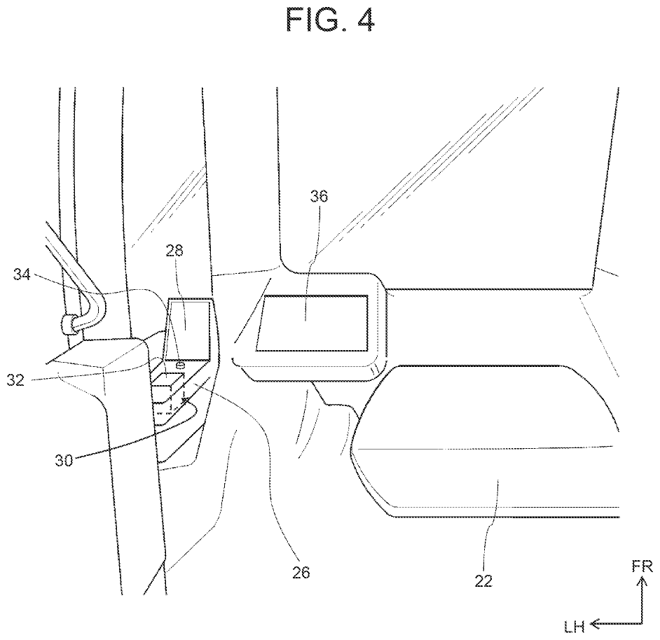

Next, details of the touch panel 28 and the emergency stop button 34 that are input devices for inputting commands for the traveling of the automatic driving vehicle 10 to the control device 70 will be described with reference to FIG. 3 to FIG. 5. First, the configuration of a vehicle cabin of the automatic driving vehicle 10 and dispositions of the touch panel 28 and the emergency stop button 34 will be described with reference to FIG. 3 and FIG. 4.

As shown in FIG. 3, at a central portion in the vehicle cabin of the automatic driving vehicle 10, there is a floor 20 for an occupant that rides on the automatic driving vehicle 10 while standing or for placing a wheelchair on which an occupant sits. Further, seats 22 for occupants are provided along a sidewall in the vehicle cabin.

Further, an operator's seat 24 on which the operator sits is provided in the vehicle cabin. FIG. 3 shows a state where a seating portion 24a of the operator's seat 24 has been moved down and a seating surface 24b has appeared. The seating portion 24a can be folded up. In the embodiment, the operator's seat 24 is provided at a position that is on the left side surface in the vehicle cabin and that is forward of and close to the door 18. However, the operator's seat 24 may be provided on the right side surface in the vehicle cabin.

An arm rest 26 extending in the front-rear direction is provided forward of the operator's seat 24. The operator can rest the arm on the arm rest 26 while sitting on the operator's seat 24. The arm rest 26 is provided above the seating surface 24b of the operator's seat 24 in a state that allows seating.

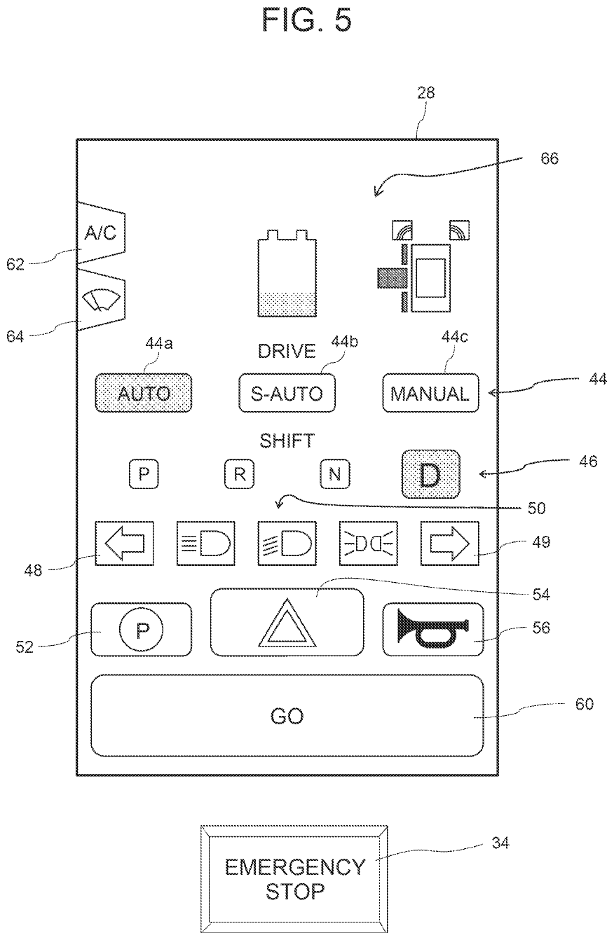

As shown in FIG. 4, at a front end portion of the arm rest 26, the touch panel 28 is provided so as to stand upward from an upper surface of the arm rest 26. The touch panel 28 is oriented to the rear side (that is, to the side of the operator's seat 24). Accordingly, the operator can operate the touch panel 28 by hand, while sitting on the operator's seat 24 and resting the arm on the arm rest 26. Through the touch panel 28, it is possible to input a vehicle speed control instruction in the automatic mode, and input apparatus control instructions to apparatuses (an indicator, a horn, a headlight, an air conditioner, a windshield wiper, and the like) provided in the automatic driving vehicle 10. Details of a display screen of the touch panel 28 will be described later with reference to FIG. 5.

In the arm rest 26, a storage portion 30 in which a mechanical operation unit is stored is provided. Through the mechanical operation unit, a driving control instruction is input to the control device 70 of the automatic driving vehicle 10. The storage portion 30 is covered by a lid 32, and in a state where the mechanical operation unit is stored in the storage portion 30, the mechanical operation unit is not exposed in the vehicle cabin. In the embodiment, the upper surface of the arm rest 26 is flush with the lid 32. Although the storage portion 30 is provided in the arm rest 26 in the embodiment, the storage portion 30 may be provided at a place other than the arm rest 26. Even in that case, the storage portion 30 may be provided at an inconspicuous place, for example, at an edge portion on one of the front, rear, right and left sides in the vehicle cabin. The mechanical operation unit is drawn out of the storage portion 30, mainly in the case where the traveling control mode of the automatic driving vehicle 10 is the manual mode. In the case where the traveling control mode of the automatic driving vehicle 10 is the automatic mode, the mechanical operation unit is ordinarily stored in the storage portion 30, for preventing an erroneous operation of the mechanical operation unit.

The emergency stop button 34 is an emergency stop operation input device for the automatic driving vehicle 10, and is provide on the upper surface of the arm rest 26. When the operator presses the emergency stop button 34, the emergency stop button 34 transmits an emergency stop signal to the control device 70, as a converted electric signal.

As shown in FIG. 4, the display 36, on which information relevant to the automatic driving vehicle 10 is displayed, is provided at a front left corner in the vehicle cabin. For example, information such as the vehicle speed of the automatic driving vehicle 10, the ambient temperature and the next station is displayed on the display 36. Similarly to the touch panel 28, the display 36 is oriented to the rear side. Thereby, the operator sitting on the operator's seat 24 can see the touch panel 28 and the display 36 side by side. As a result, the operator can visually recognize both the touch panel 28 and the display 36.

Next, a screen of the touch panel 28 will be described with reference to FIG. 5. FIG. 5 shows a display screen when the automatic driving vehicle 10 is at a stop in the automatic mode. As described above, the touch panel 28 is a GUI device that includes the screen on which the operation element is displayed, and accepts the operation by the operator when the operator selects the operation element. On the touch panel 28, a traveling control mode button 44, a shift button 46, indicator buttons 48, 49, a light button 50, a P brake button 52, a hazard button 54, a horn button 56, a GO button 60, an air conditioner tab 62 and a windshield wiper tab 64 are displayed as operation elements.

The traveling control mode button 44 is a button for inputting an instruction of alteration of the traveling control mode, and includes three buttons: an automatic mode selection button 44a for selecting the automatic mode, a semi-automatic mode selection button 44b for selecting the semi-automatic mode, and a manual mode selection button 44c for selecting the manual mode. The traveling control mode button 44 is set such that the traveling control mode button 44 can be operated only while the automatic driving vehicle 10 is at a stop. In the example shown in FIG. 5, “AUTO” indicating the automatic mode is selected.

The shift button 46 is a button for inputting a gearshift control instruction. In the embodiment, in the automatic mode, the shift button 46 is set such that the shift button 46 cannot be operated, and the gearshift cannot be performed by the operator's operation.

The indicator buttons 48, 49 are buttons for controlling the indicator. The light button 50 is a button for controlling a headlight and a taillight. The P brake button 52 is a button for inputting an instruction of actuation or release of an electric parking brake. The hazard button 54 is a button for causing a hazard light to act. The horn button 56 is a button for causing a horn to act.

The GO button 60 is a button for inputting a movement start instruction to the control device 70 when the automatic driving vehicle 10 is in the automatic mode. When the GO button 60 is operated, the automatic driving vehicle 10 starts to travel in the automatic mode by the traveling control from the control device 70.

The air conditioner tab 62 is a button for controlling the air conditioner. The windshield wiper tab 64 is a button for controlling the windshield wiper. When the air conditioner tab 62 is touched, various buttons for controlling the air conditioner are displayed, and when the windshield wiper tab 64 is touched, various buttons for controlling the windshield wiper are displayed.

Further, the battery charge amount of the automatic driving vehicle 10, the opening-closing state of the door 18, the state of the slope, the detection states of various sensors provided in the automatic driving vehicle 10, or the like are displayed at an upper portion 66 of the touch panel 28.

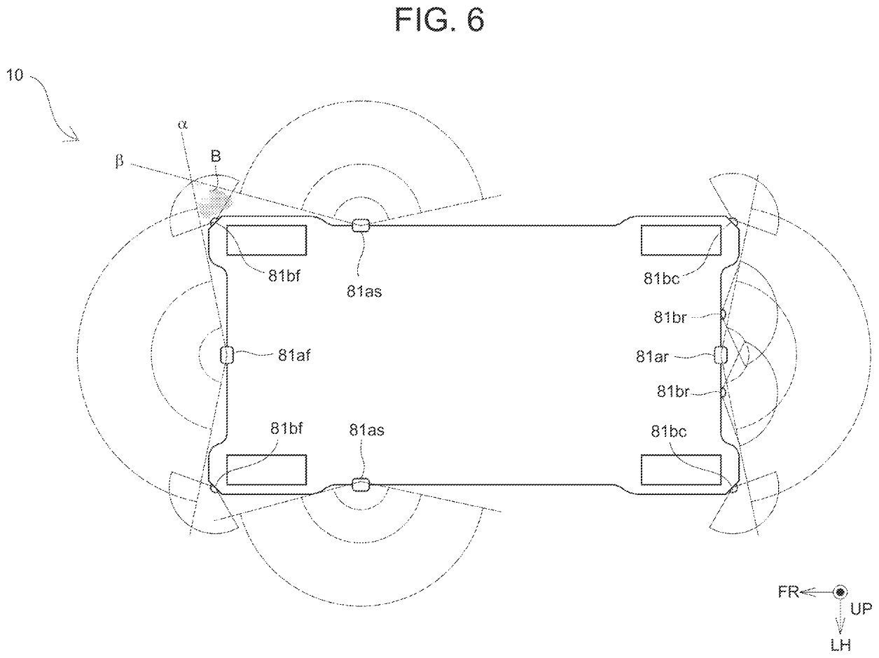

Next, dispositions of the LIDAR 81a and the clearance sonar 81b of the physical body detection sensor 81 will be described with reference to FIG. 6.

As shown in FIG. 6, LIDARs 81as are attached to right and left side surfaces of the automatic driving vehicle 10, slightly forward of centers of the right and left side surfaces, respectively. In addition, LIDARs 81af, 81ar are provided on centers of front and rear surfaces of the automatic driving vehicle 10, respectively. Further, clearance sonars 81bf are attached to both corner portions of the front side of the automatic driving vehicle 10, respectively. In addition, clearance sonars 81bc are provided at both corner portions of the rear side of the automatic driving vehicle 10, respectively. Further, clearance sonars 81br are provided at the sides of the LIDAR 81ar at the center of the rear surface, respectively.

In FIG. 6, fan-shaped broken lines show detection ranges of the LIDARs 81as, 81af, 81ar, and fan-shaped solid lines show detection ranges of the clearance sonars 81bf, 81bc, 81br.

A broken line α and a broken line β show a detection range of the LIDAR 81af disposed on the front surface and a detection range of the LIDAR 81as disposed on the side surface, respectively. In the figure, a B region shows a range where the LIDARs 81af, 81as cannot perform the detection. In the automatic driving vehicle 10 in the embodiment, the clearance sonars 81bf are disposed at the corner portions of the front side, and thereby, it is possible to detect a physical body in the B region.

Next, the behavior of the automatic driving vehicle 10 configured as described above will be described with reference to FIG. 7 to FIG. 11. Descriptions will be made below, assuming that the automatic driving vehicle 10 travels along a management route 94 shown in FIG. 7 by the automatic driving while communicating with the management center 96 through a communication network 97.

In the example shown in FIG. 7, the management route 94 is a circuit, and four automatic driving vehicles 10 operate at nearly equally spaced intervals. Stations 95a to 95h are installed at appropriate spaced intervals for ease of access by users. For example, the station 95a is a transfer station for bus stops and railroad stations that are not on the management route 94, and the other stations are stations near user's homes and the like. Further, a garage 90 is connected with one spot (an inlet passage and an outlet passage) on the management route 94. The automatic driving vehicle 10 moves from a parking zone 91 of the garage 90 to a vehicle entrance box 92 or vehicle entrance box 93, and enters the management route 94 from the vehicle entrance box 92 or vehicle entrance box 93 or exits (goes off) from the management route 94 to the garage 90.

In FIG. 7, the management route 94 is schematically shown. The real management route 94 is not a simple management route shown in FIG. 7, and includes an intersection, a turning point and the like. At the intersection, the automatic driving vehicle 10 decelerates and performs safety check based on the camera image, to pass through the intersection. As necessary, the automatic driving vehicle 10 stops and performs the safety check at the intersection, to turn right or left. This behavior may be automatically performed, or may be performed in response to the operation by the operator.

A behavior after the automatic driving vehicle 10 stopped at the parking zone 91 in the garage 90 moves from the parking zone 91 to the vehicle entrance box 93 and before the automatic driving vehicle 10 enters the management route 94 will be described below.

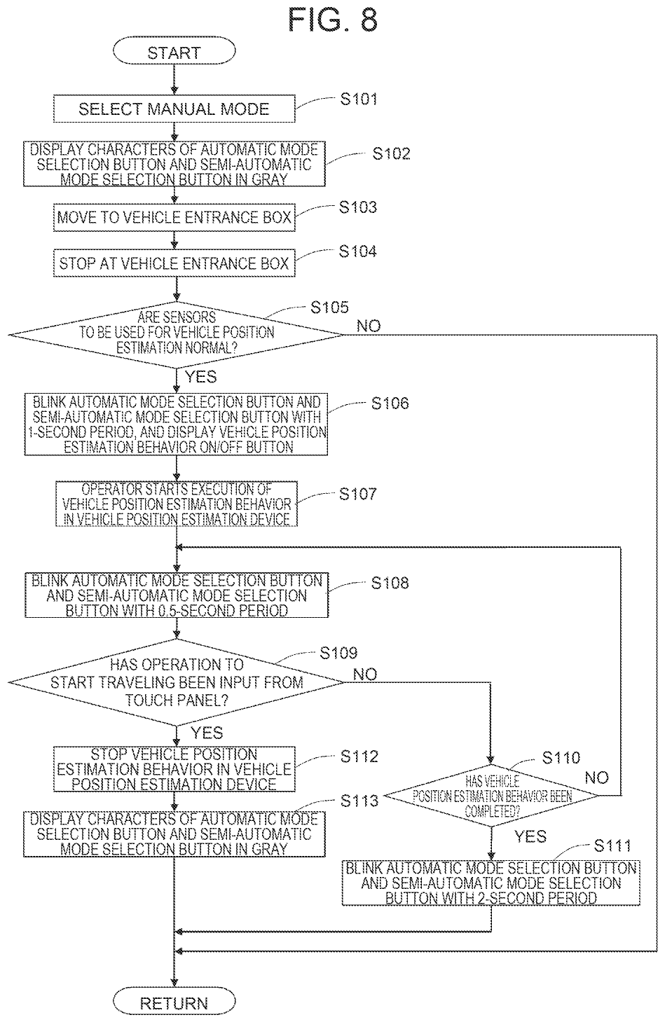

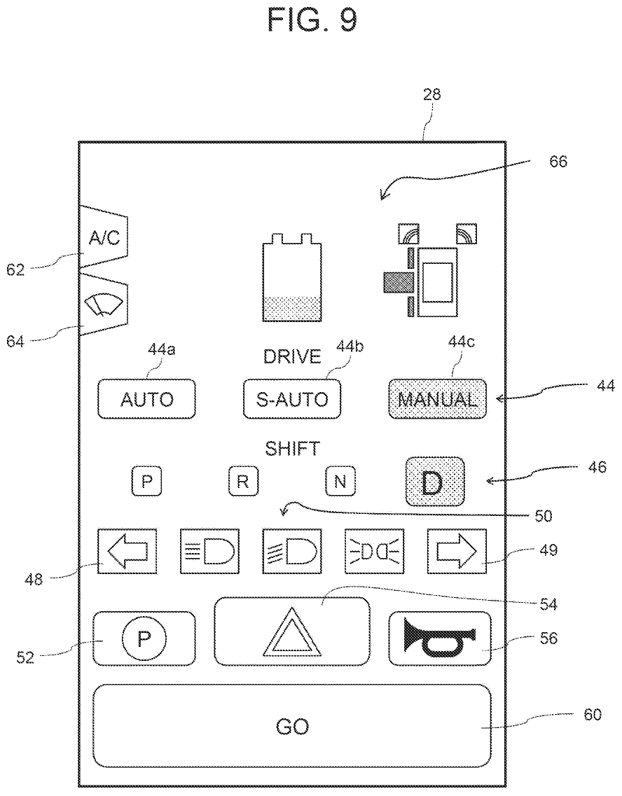

First, the automatic driving vehicle 10 parks at the parking zone 91 in the garage 90 and performs operation preparations such as the charge of the battery 87. After the charge of the battery 87, the operator gets on the automatic driving vehicle 10, and starts the automatic driving vehicle 10 by pressing a start button of the automatic driving vehicle 10. When the automatic driving vehicle 10 starts and the operator selects the manual mode by pressing the manual mode selection button 44c on the touch panel 28 as shown in step S101 of FIG. 8, the manual mode selection button 44c on the touch panel 28 is lighted as shown in FIG. 9, and the automatic driving vehicle 10 can travel in the manual mode. At this time, the vehicle position estimation behavior in the vehicle position estimation device 74 is not being executed, and the automatic mode and the semi-automatic mode cannot be selected. Therefore, as shown in step S102 of FIG. 8 and FIG. 9, the characters of “AUTO” and “S-AUTO” that are the automatic mode selection button 44a and the semi-automatic mode selection button 44b on the touch panel 28 are displayed in gray. Thereby, the operator recognizes that the vehicle position estimation behavior has not been executed.

Next, the operator draws the mechanical operation unit out of the storage portion 30, and executes the manual operation. The operator moves the automatic driving vehicle 10 from the parking zone 91 to the vehicle entrance box 93 as shown in step S103 of FIG. 8 and shown by an arrow 98 of FIG. 7, and stops the automatic driving vehicle 10 on the vehicle entrance box 93 as shown in step S104 of FIG. 8 and FIG. 7.

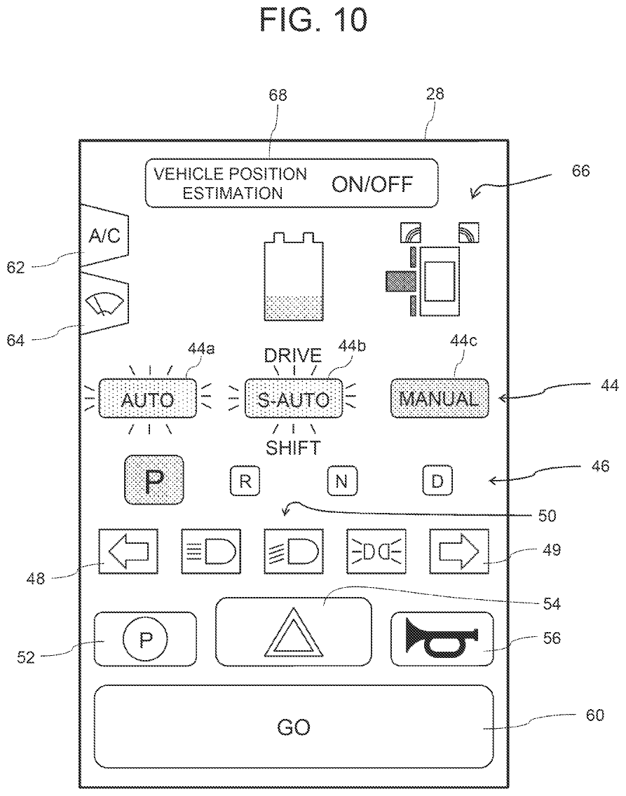

When the automatic driving vehicle 10 stops at the vehicle entrance box 93 and “Parking” of the shift button 46 is selected, the control device 70 checks whether the GPS receiver 79, sensors such as the traveling state detection sensor 80 and the physical body detection sensor 81, and apparatuses such as the camera 82, which are necessary for the vehicle position estimation behavior, are normally behaving, as shown in step S105 of FIG. 8. In the case where the control device 70 determines that the apparatuses and the sensors are normally behaving, the control device 70 determines that the vehicle position estimation device 74 is in a state where the vehicle position estimation behavior can be executed, and proceeds to step S106 of FIG. 8. Then, in step S106 of FIG. 8, the control device 70 blinks the automatic mode selection button 44a and semi-automatic mode selection button 44b on the touch panel 28 with a 1-second period, as shown in FIG. 10. Further, the control device 70 displays a vehicle position estimation behavior ON/OFF button 68 that is an operation element for executing and stopping the vehicle position estimation behavior, on the screen of the touch panel 28. Thereby, the control device 70 gives notice that the vehicle position estimation device 74 is in an execution standby state, to the operator.

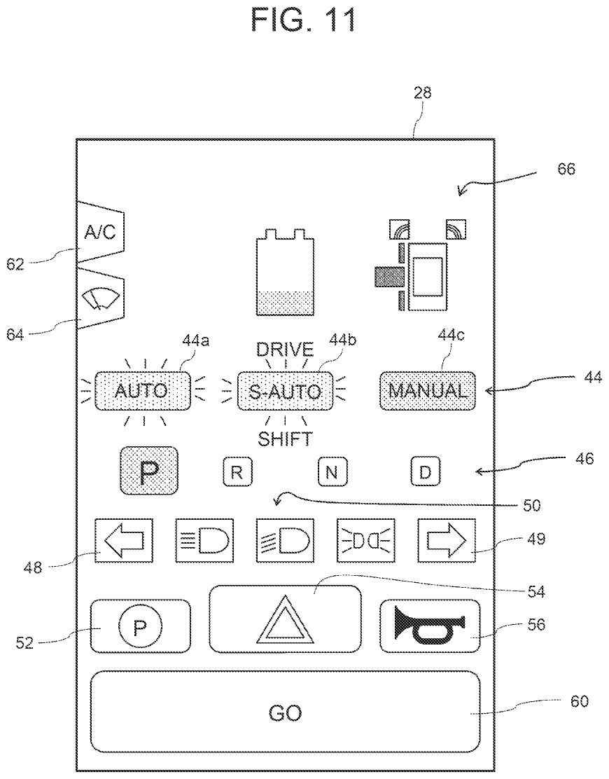

Next, in the case where the operator causes the vehicle position estimation device 74 to execute the vehicle position estimation behavior by operating the vehicle position estimation behavior ON/OFF button 68 as shown in step S107 of FIG. 8, the control device 70 blinks the automatic mode selection button 44a and semi-automatic mode selection button 44b on the touch panel 28 with a 0.5-second period, as shown in step S108 of FIG. 8 and FIG. 11. Further, the control device 70 ends the display of the vehicle position estimation behavior ON/OFF button 68 on the screen of the touch panel 28.

While the vehicle position estimation device 74 is executing the vehicle position estimation behavior, the control device 70 monitors whether an operation to start the traveling of the automatic driving vehicle 10 has been input from the touch panel 28, as shown in step S109 of FIG. 8. Examples of the operation to start the traveling include an operation to select “Drive” of the shift button 46 and an operation to input the start of the traveling from the mechanical operation unit.

In the case where the determination of NO is made in step S109 of FIG. 8, the control device 70 proceeds to step S110 of FIG. 8, and determines whether the vehicle position estimation behavior has been completed. In the case where the determination of NO is made in step S110 of FIG. 8, the control device 70 returns to step S108 of FIG. 8, and continuously blinks the automatic mode selection button 44a and semi-automatic mode selection button 44b on the touch panel 28 with a 0.5-second period.

In the case where the determination of YES is made in step S110 of FIG. 8, the control device 70 proceeds to step S111 of FIG. 8, and alters the blinking period of the automatic mode selection button 44a and semi-automatic mode selection button 44b on the touch panel 28 shown in FIG. 11, from 0.5 seconds to 2 seconds, and ends the behavior.

When the vehicle position estimation behavior has been completed, information about the position and oriented direction of the automatic driving vehicle 10 on the automatic driving map 78 is input from the vehicle position estimation device 74 to the control device 70. Thereby, the control device 70 can control the traveling of the automatic driving vehicle 10 in the automatic mode or the semi-automatic mode.

After the vehicle position estimation behavior has been completed, the control device 70 checks that the door 18 is closed, and then starts the automatic driving while communicating with the management center 96. The automatic driving vehicle 10 enters the management route 94 from the vehicle entrance box 93 as shown by an arrow 99 in FIG. 7, and automatically travels along the management route 94.

On the other hand, in the case where the determination of YES is made in step S109 of FIG. 8, the control device 70 proceeds to step S112 of FIG. 8, and stops the vehicle position estimation behavior in the vehicle position estimation device 74. Then, the control device 70 proceeds to step S113 of FIG. 8. The control device 70 displays the characters of “AUTO” and “S-AUTO” that are the automatic mode selection button 44a and the semi-automatic mode selection button 44b on the touch panel 28 in gray, as shown in FIG. 9, and ends the behavior. Thereby, the operator recognizes that the vehicle position estimation behavior has not been executed.

In the case where the determination of NO is made in step S105 of FIG. 8, the control device 70 determines that it is difficult to execute the vehicle position estimation behavior in the vehicle position estimation device 74, and ends the behavior. On this occasion, the characters of “AUTO” and “S-AUTO” that are the automatic mode selection button 44a and the semi-automatic mode selection button 44b on the touch panel 28 are continuously displayed in gray as shown in FIG. 9, and thereby, the operator recognizes that the vehicle position estimation behavior has not been executed.

As described above, the automatic driving vehicle 10 in the embodiment displays the behavior state of the vehicle position estimation device 74 on the touch panel 28 that can be visually recognized by the operator, and therefore, the operator can recognize the behavior state of the vehicle position estimation device 74.

The automatic driving vehicle 10 in the embodiment blinks the automatic mode selection button 44a and semi-automatic mode selection button 44b on the touch panel 28 with a 1-second period. Thereby, it is possible to cause the operator to recognize that the vehicle position estimation device 74 is in the execution standby state, and it is possible to prompt the operator to cause the vehicle position estimation device 74 to behave and execute the vehicle position estimation behavior before the start of the automatic driving. At the same time, by displaying the vehicle position estimation behavior ON/OFF button 68, it is possible to prompt the operator to cause the vehicle position estimation device 74 to behave and execute the vehicle position estimation behavior before the start of the automatic driving.

Thereby, even when a long time is required for accurately estimating the position and oriented direction of the automatic driving vehicle 10 on the automatic driving map 78 based on the outputs from the GPS receiver 79, the traveling state detection sensor 80 and the physical body detection sensor 81, the image from the camera 82 and the like in the vehicle position estimation behavior, it is possible to complete the vehicle position estimation behavior before the start time of the automatic driving and to operate the automatic driving vehicle 10 on schedule.

In the case where the operation to start the traveling of the automatic driving vehicle 10 has been input during the execution of the vehicle position estimation behavior, the vehicle position estimation behavior is stopped. Therefore, it is possible to avoid decrease in the estimation accuracy for the vehicle position.

The vehicle position estimation behavior in the vehicle position estimation device 74 is the behavior of estimating the position and oriented direction of the automatic driving vehicle 10 on the automatic driving map 78 based on the outputs from the GPS receiver 79, the traveling state detection sensor 80 and the physical body detection sensor 81, the image from the camera 82, and the like, in the above description, but is not limited to this.

For example, in the case where signals from GPS satellites cannot be received and the GPS receiver 79 cannot detect the absolute position of the automatic driving vehicle 10, it is possible to detect the absolute position of the automatic driving vehicle 10 by causing the automatic driving vehicle 10 to stop on the vehicle entrance box 93 for which position information is known, and to execute the vehicle position estimation behavior.

For the display of the behavior state of the vehicle position estimation device 74, the display on the touch panel 28 is shown in gray or is blinked in the above description, but without being limited to them, signs such as “EXECUTION STANDBY”, “EXECUTION” and “EXECUTION COMPLETION” may be output on the touch panel 28. Further, the blinking period when the behavior state is displayed by blinking the display on the touch panel 28 is 0.5 seconds, 1 second or 2 seconds in the above description, but without being limited to them, appropriate periods allowing the operator to easily recognize the behavior state may be selected.

Further, the behavior state of the vehicle position estimation device 74 is displayed on the screen of the touch panel 28 in the above description, but without being limited to this, the behavior state of the vehicle position estimation device 74 may be displayed on the display 36.

What is claimed is:

1. An automatic driving vehicle comprising:
a vehicle position estimation device that estimates a vehicle position;
a display device that is capable of being visually recognized by an operator; and
a control device that controls behaviors of the vehicle position estimation device and the display device, wherein
the control device causes the display device to display a behavior state of the vehicle position estimation device.

2. The automatic driving vehicle according to claim 1, wherein:
the control device performs traveling control, and is capable of switching a traveling control mode between an automatic mode and a manual mode; and
the control device gives notice that the vehicle position estimation device is in an execution standby state, to the operator, when the vehicle position estimation device has not completed a vehicle position estimation behavior in a state where the traveling control mode is the manual mode.

3. The automatic driving vehicle according to claim 2, wherein:
the display device is a GUI device including a screen on which an operation element is displayed, the GUI device accepting an operation by the operator when the operator selects the operation element; and
the control device causes the display device to display another operation element by which the operator selects execution or stop of the vehicle position estimation behavior, when the vehicle position estimation device has not completed the vehicle position estimation behavior in the state where the traveling control mode is the manual mode.

4. The automatic driving vehicle according to claim 1, wherein:
the display device is a GUI device including a screen on which an operation element is displayed, the GUI device accepting an operation by the operator when the operator selects the operation element;
the control device is capable of switching a traveling control mode between an automatic mode and a manual mode, and performs traveling control based on an operation by the operator that is accepted by the display device, when the traveling control mode is the manual mode; and
the control device stops a vehicle position estimation behavior in the vehicle position estimation device, in a case where an operation to start traveling is input from the display device when the vehicle position estimation device is executing the vehicle position estimation behavior during vehicle stop in a state where the traveling control mode is the manual mode.

5. The automatic driving vehicle according to claim 1, wherein:
the control device performs traveling control, and is capable of switching a traveling control mode between an automatic mode and a manual mode; and
the control device causes the vehicle position estimation device to execute a vehicle position estimation behavior during vehicle stop at a predetermined position for which position information is known, in a state where the traveling control mode is the manual mode.
